(19) United States
(12) Patent Application Publication
(10) Pub. No.: US 2011/0048474 A1
(43) Pub. Date: Mar. 3, 2011

(54) SHOES REFRESHING, WASHING AND DRYING MACHINE

(76) Inventor: SOO KIL KIM, Wheeling, IL (US)

(21) Appl. No.: 12/551,677

(22) Filed: Sep. 1, 2009

(51) Int. Cl. B08B 3/00

(52) U.S. Cl. 134/115 R

(57) ABSTRACT

Present invention is an improved version of Shoe Drying Apparatus (ref: U.S. Pat. No. 6,845,569) which was applied by Soo Kil Kim on Jan. 25, 2005. Present invention sterilizes, deodorizes and dries all types of shoes including leather shoes and gym shoes by using mixed air circulation and special solution, sodium hydrogen carbonate solution (NaHCO3) (referred here in after as “Solution”), which includes alkali, carbonated water and enzyme in a short period of time. There are main control devices located on the top, such as electric circuit breaker, ventilating fan, electric heater, ultraviolet rays generator, ozone generator, anion generator, silver nano generator and lights. The bottom of the invention consists of many rooms, and separated doors are attached to each room. There are shoe hangers in each room. The invention jets the Solution into the shoes to soak out dirt and stain absorbed into the shoes. Mixed air which includes ozone, nano, anion and ultraviolet rays comes out shortly and dries the shoes.

### DETAILED DESCRIPTION OF THE PREFERRED EMBODIMENT

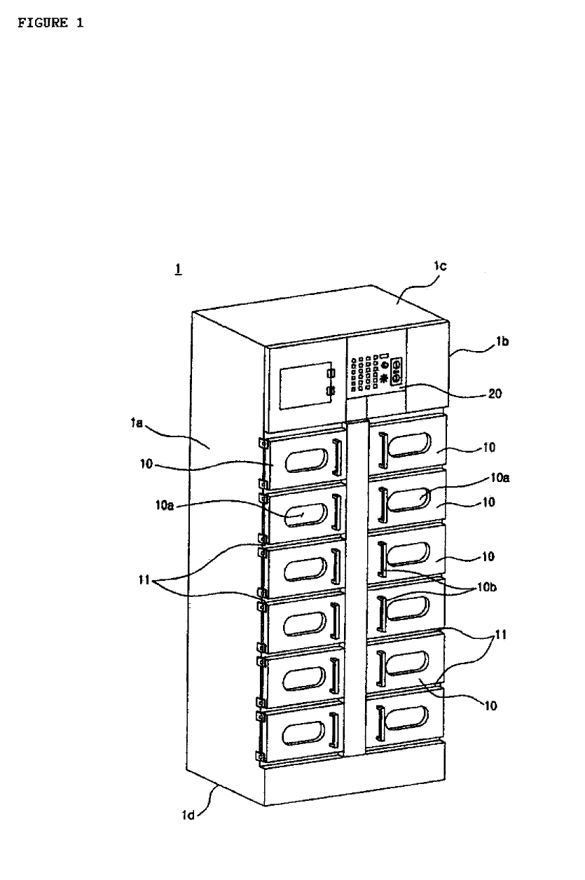

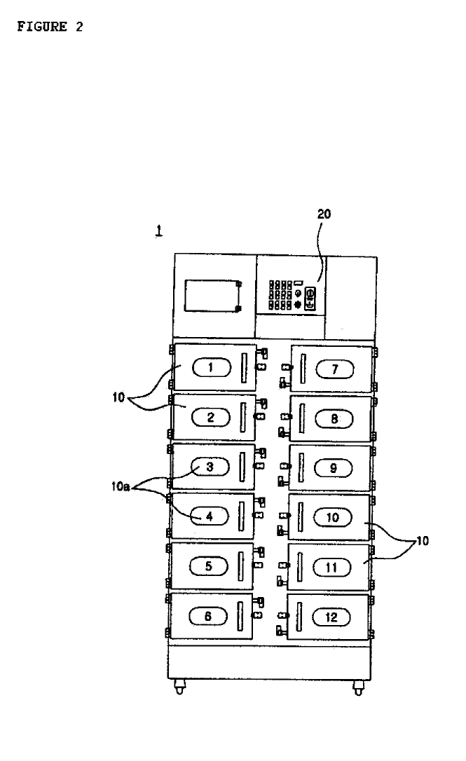

Referring now to FIG. 1 and FIG. 2, heat insulating materials are installed in left and right panels (1a) (1b), top and bottom panels (1c) (1d) and back panel (1e). This structure forms housing (1) of the machine. There is a space between back panel (1e) and front side of the housing (1). When a vertical panel (2) is placed between top and bottom panels (1c) (1d) perpendicular space (3) is created.

By inserting dividers (4) to the vertical panel (2) in the housing (1), about 5 through 12 rooms (5) are created. Each door (10) is placed in front of the rooms (5). The machine forms the housing by placing panels on the top and bottom. The housing itself is actually divided by net type dividers (4), so air comes in and out freely.

The heat insulating material installed in main body (11) and doors (10) make efficient insulation by shutting off air circulation from outside completely. This structure minimizes loss of heat inside of the housing (1).

The doors (10) are composed with limit switch and solenoid, so they can be closed and opened easily and conveniently. About 0.1 mm˜300 mm of space between the doors (10) and the main body (11) of the machine helps efficient air circulation. This space also controls humidity while the machine is working for 30 minutes.

The invention does not have duct system, so inside temperature goes up very slowly when there are lots of moistures inside of the machine. This usually happens when inside temperature is about 30 degree, and there are lots of moistures. However, this moisture inside of the machine can be controlled when outside air comes into the machine through the space between doors and the main body and meets with the air inside of the machine. If there is too much moisture, some are absorbed in the air through the space between doors (10) and the main body (11). Thus, by controlling moisture inside of the machine, it increases inside temperature efficiently.

Doors (10) are made of clear material (10a), so inside of rooms are visible. Handles (10b) are attached to each door.

The size of the machine is flexible. There is not fixed size or form for the machine. If it is used in a coin laundry, it can be small as possible like 600 mm˜1400 mm width, 300 mm˜1400 mm length, and 1200 mm˜2000 mm height for the small space.

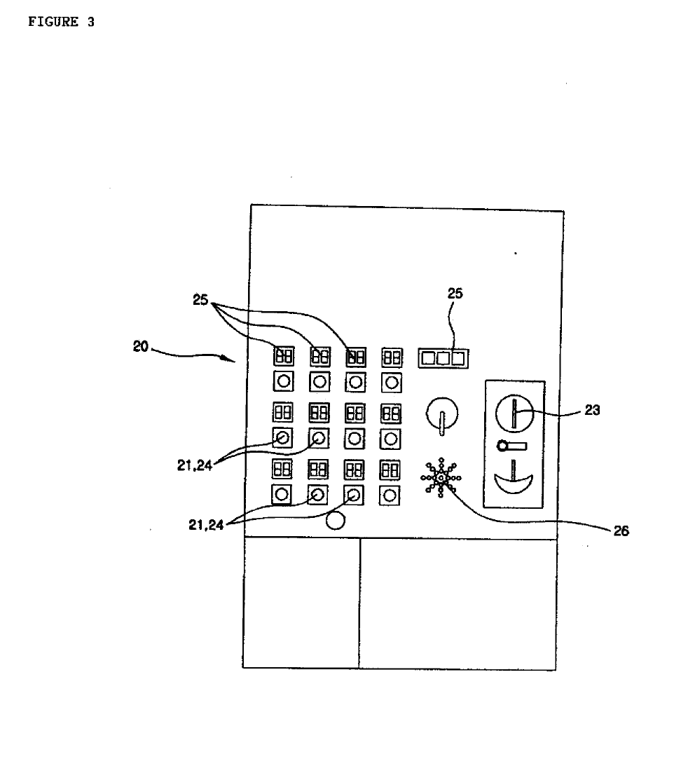

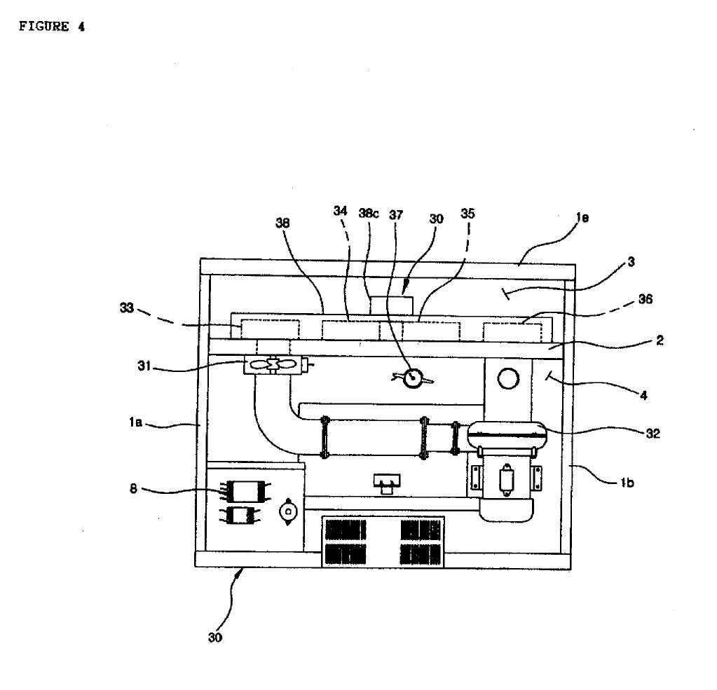

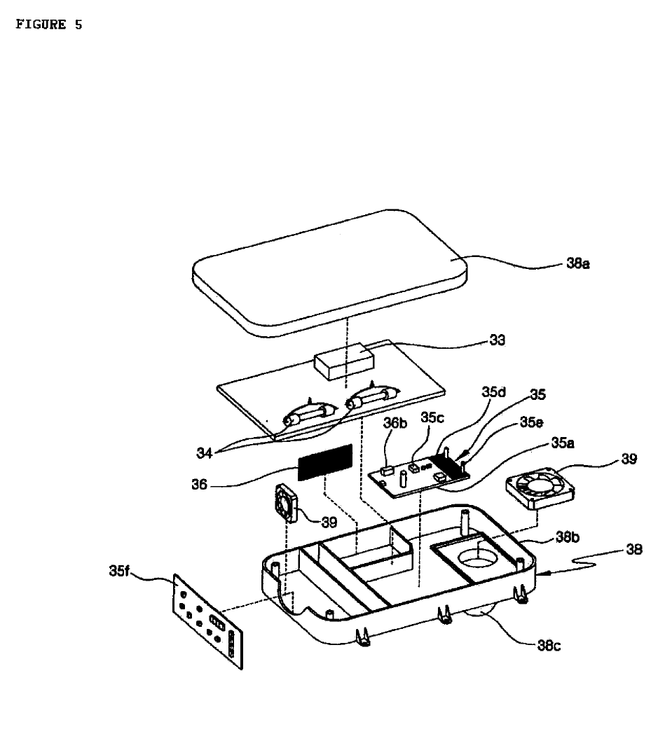

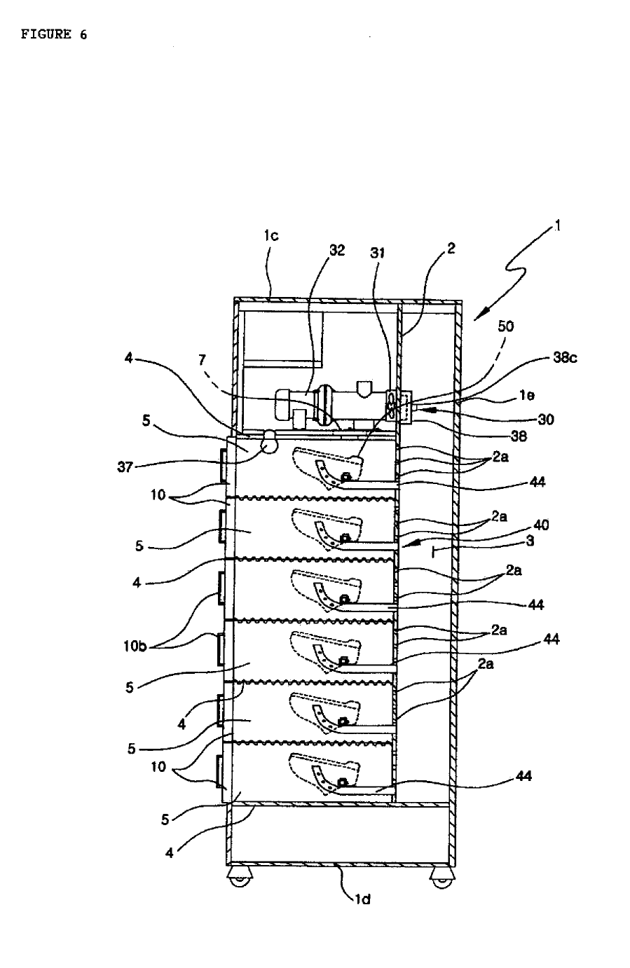

As mentioned with FIG. 3 and FIG. 6, there are buttons (21) for each door, room numbers (24), screen (22), a place to insert coin (23), password (25), and speakers (26) on control panel (20) which is located on the top front side of the housing (1)

The control panel (20) and operating gauge (30) are controlled by Control system (100).

The operating gauge (30) is composed with ultraviolet rayers generator (33), ozone generator (34), anion generator (35), and nano generator which creates mixed air from a case (38) which is made of a bottom (38a) and a cover (38b).

The mixed air made in this case (38) flows through pipe (38a) and passes perpendicular space (3) by a fan (39) in the case It finally goes into the shoe hanger to dry, sterilize and deodorize the shoes (40) by ventilating fan (31) and electric heater (32). In other words, the ultraviolet layer generator (33), ozone generator (34), anion generator (35) and nano generator create mixed air in the perpendicular space (3) and flows through mixed air inhaul hole (2a) on vertical panel (2) by ventilating fan (31) and electric heater (32). It finally goes to each room and dry, sterilize and deodorize the shoe on the shoe hanger (40).

The dividers in each room (5) are net style, so mixed air circulates freely.

Some mixed air in perpendicular space (3) moves to shoe hanger (40) and dries, sterilizes and deodorizes the shoes on the hanger.

The mixed air which contains ozone, anion and nano typically moves top to bottom. Once mixed air dries the inside of the shoes, its flow moves bottom to top. This air movement continues and completely sterilizes, deodorizes and dries the shoes on the hanger (40).

The material of ozone generator in the machine (30) is made of pure quartz (Sio2 99% purity), and output of ultraviolet rays (25.37 mm) are same as germicidal lamp. In addition, 184.9 mm of ultraviolet rayers that generate ozone makes stronger deodorization and sterilization on the area where ultraviolet rayers do not reach.

In general, ozone creation occurs when electrical high voltage is used; however, harmful substances, such as nitrogen oxide (Nox, Sox) occur as well. There is an issue with using electrical high voltage. However, present invention creates ozone by using pure ‘light,’ so harmful substances do not come out. It also controls the amount of ozone and uses fixed amount that is only needed. The permissible ozone concentration is under 0.05 ppm. Also, nano is created by well known nano generator (36). Anion generator (35) is created when PBC board (35a) gets 5V power from outside and transforms 37 KHZ into 1.6 KV through a transformer (35b) in the anion generator. Once it amplifies 3 times by using condenser (35c), output power is raised to 4.8 KV.

When output is discharged from electric discharge brush (35d) and trans double controlled electric discharge panel (35e) on PBC board (35a), anion is generated. Therefore, electric discharge brush (35d) discharges electricity to discharged electrode (35e) and generates anions that are safe to human body.

The present invention has an electric discharge brush (35d) which is composed with 1000 fibers and discharges about 200 millions of anions per 1 cc.

Thus, ozone generator (34) maintains permissible ozone concentration at 0.05 ppm, and anion generator (35) exposes unlimited amount of anions. Finally, Control system (100) controls appropriate the amount of ozone and anions for human body.

Sometimes inside of machine contains high humidity when the machine is used, and this cause inside temperature to increase slowly. In order to dry shoes effectively, the machine let air comes in from the space between doors and the body of the machine and meet with moisture inside of the machine. Thus, it finally controls the moisture inside of the machine by using air circulation through the space.

When the machine does not dry shoes completely, germs, bacteria or foul smell can comes out. It is impossible to sterilize the shoes in this environment. Montmorillonite or zeolite is available to absorb any germs and odor in this case.

Conditions of present invention, such as temperature, hours, size of the machine, and number of rooms can be determined by various factors. Appropriate temperature of the machine is 30˜90 degrees in 10-60 minutes of use. It is import to use proper size of metal plates to sterilize, deodorize and dry the shoes completely. When the machine needs to dry gym shoes in wet condition, the metal panel should be 0.1-3 cm and maintain 50-90 degrees. This temperature can be controlled and maintained by in heat sensor program (7) and the control system (100).

Under this circumstance, it is beneficial to use in coin laundry place while a user is washing or drying his or her clothes. Also, army base, fire department, industrial complex, golf range, and sport facility are recommended places where a user can use the machine in short period of time.

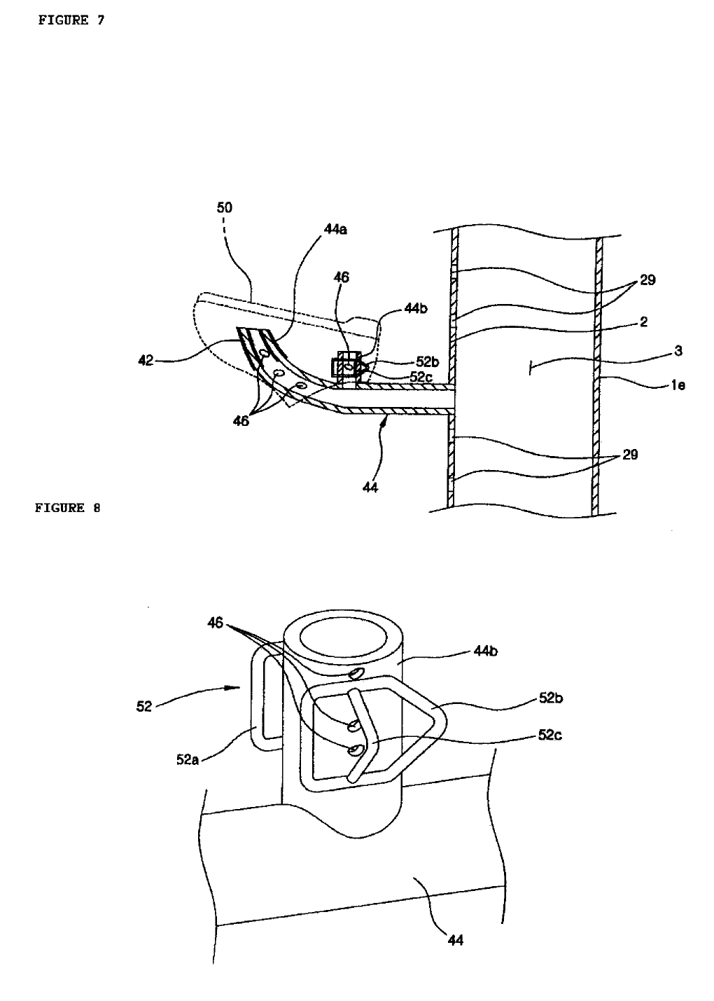

FIGS. 6 to 8 shows how to place the shoes on the hanger. The shoe hanger (40) places the shoes upside down. The slope of the shoes and the hanger should be 90 degree or less even though shoes are placed perpendicularly to the hanger in order to sterilize, deodorize and dry the shoes completely.

The present invention is able to use for leather shoes that can not be washed in the water due to special material. When a person wears shoes for long time, the shoes absorb sweat and cause foul smell. It is hard for a person to maintain healthy sanitation.

This invention removes odor, dirt, stain, bacteria, and germs from the shoes (50) and refreshes the shoes.

The shoe hanger (40) is connected to the vertical panel (2), perpendicular space (3) and exhaust hole (44) horizontally. The exhaust hole (44) is composed with the 1^{st} air exhaust hole (44a) that is curved and extended to upper area and the 2^{nd} exhaust hole (44b) which is extended from middle to upper area.

Fastener (52) prevents the shoes slipping from hanging area, and it is mounted on matching opposite surface of the second air exhaust hole (44b). It is composed with horizontal holding structure (52a) (52b) and an attached vertical holding structure (52c).

There are a lot of holes (46) on the 1^{st} and 2^{nd} air exhaust holes of exhaust hole (44) which are connected to the shoe hangers. Gold nano (42) is scattered inside and the out side of rims and multiplies sterilizing and deodorizing effect.

The shoes (50) are placed at the 1^{st} and 2^{nd} air exhaust holes (44a) (44b) and fixed by the fastener (52). Once air from air distribution panel (42) passes through the 1^{st} and 2^{nd} air exhaust holes (44a, 44b) and ventilation hole (46), it finally goes inside of the shoes. The 1^{st} and the 2^{nd} air exhaust holes (44a) (44b) are adjustable. It could face down if it is needed. In this case, the shoes (50) are placed in the opposite way.

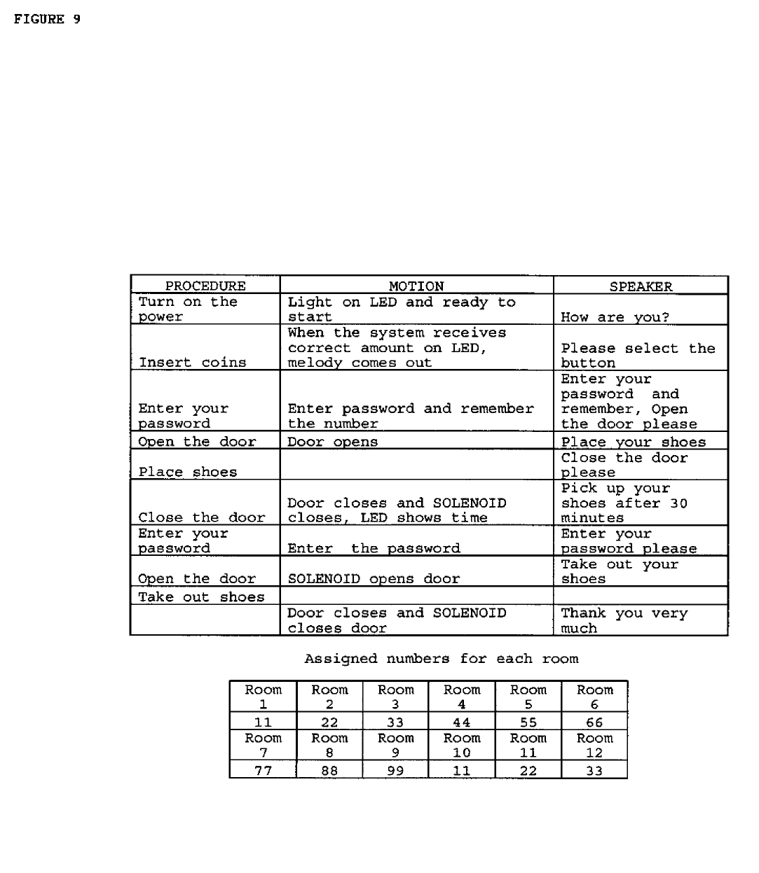

FIG. 9 shows how this machine works in detail. For an example, if a user inserts coins into the machine, speaker says, “Hello” and “Please select the button.” The user selects the number, and the machine says, “Please open the door.” Once the user places shoes in the machine, the machine says, “Please pick up the shoe after 30 minutes.” The light comes on in the room, and machine starts working.

Mixed air which includes ultraviolet layer, ozone, anion and nano is created by each generator (33, 34, 35 and 36). It passes through shoe hanger (40) and goes into shoes by ventilating fan (31) and electric heater (32). It sterilizes, deodorizes and dries the inside of the shoes, and another air which is created through vertical (2) moves each room through mixed air inhaul hole (2a) and do the same work for the external side.

There is a sensor (7) on horizontal panel (4) controls the temperature of the machine, and the screen keep updates the temperature and time. Once job is completed after 30 minutes, it says, “Dry is completed.”

The sensor is connected to electric relay (8) electronically. Once it reads temperature of a room (5), it sends a signal to control system. This controller system reads the signal and decides if the temperature is high or now. If it is higher than 75 degree, the electric relay (8) is turned off and electric heat (31) and ventilating fan (32) stops as well. If the temperature is lower than 75 degree, electric relay is turned on and electric heat (31) and ventilating fan (32) start working and maintain the temperature at 75 degree.

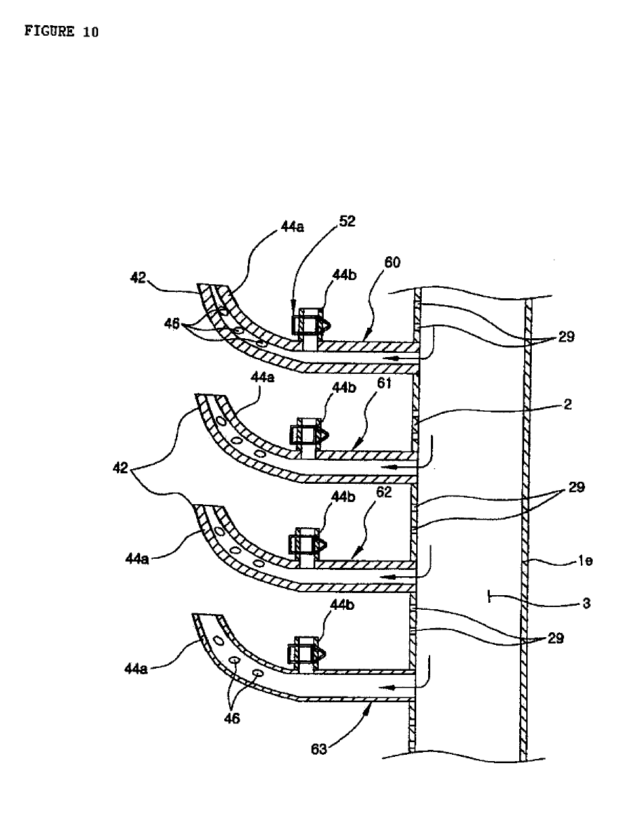

FIG. 10 shows detail diagram of the shoe hanger (40). There are different sizes of exhaust holes (44) and how the air moves into the holes. The mixed air in perpendicular space (3) moves top to bottom, so the hole on the 1^{st} air exhaust hole (60) is smaller than the 4^{th} air exhaust hole. The sizes of air exhaust holes get bigger as they go down.

Since upper area has high pressure compare to lower area, smaller hole on the 1^{st} air exhaust hole (60) controls the amount of air goes out. This means only limited amount of air discharges. On the other side, bigger hole on the 3^{rd} air exhaust hole (64) discharges more amount of air. When air pressure and sizes of holes are considered, amount of air discharged is same even if there are different sizes of holes on the 1^{st}, 2^{nd}, 3^{rd} and 4^{th} air exhaust holes (60) (61) (62)(63).

Drying time for the 1^{st}, 2^{nd}, 3^{rd} and 4^{th} air exhaust holes (60) (61) (62) (63) are same regardless of their heights and sizes. This invention has only 4 air exhaust holes, but there could be more than 4 if it is needed. Their sizes of holes are getting bigger top to bottom.

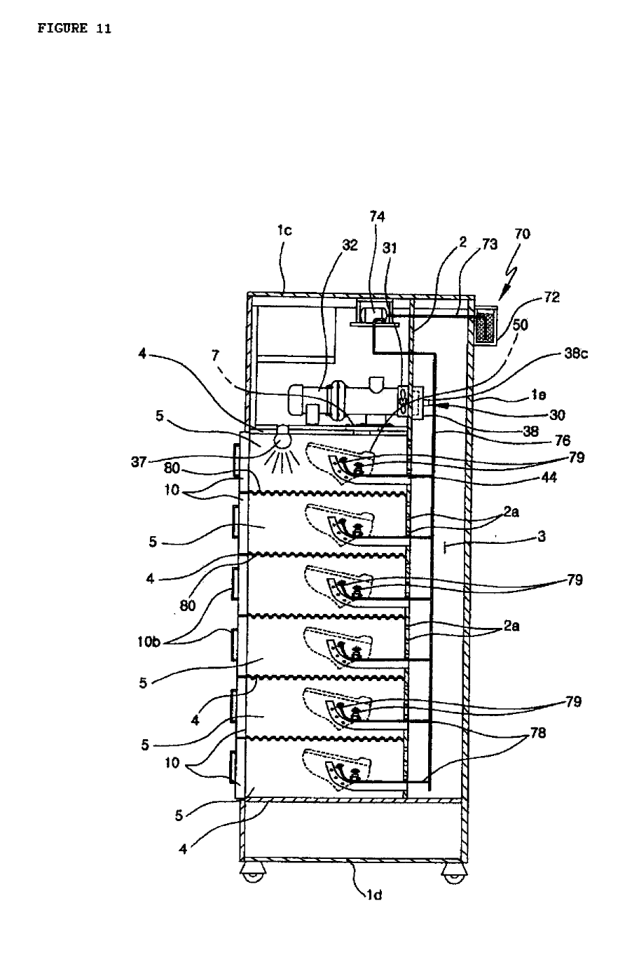

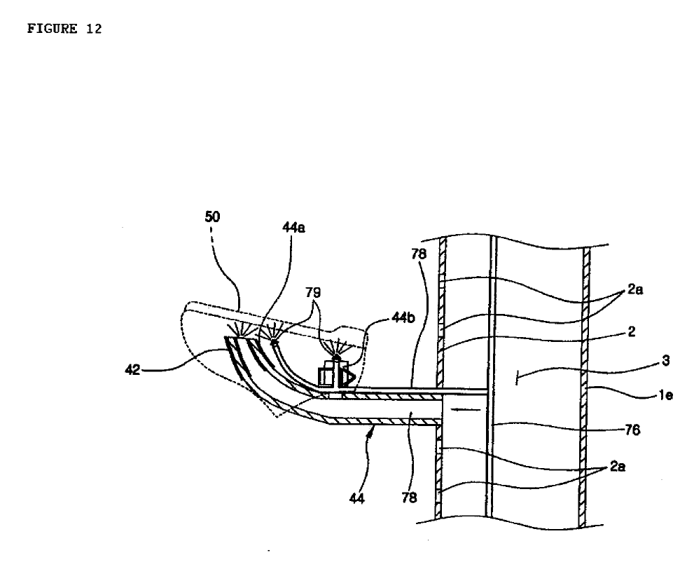

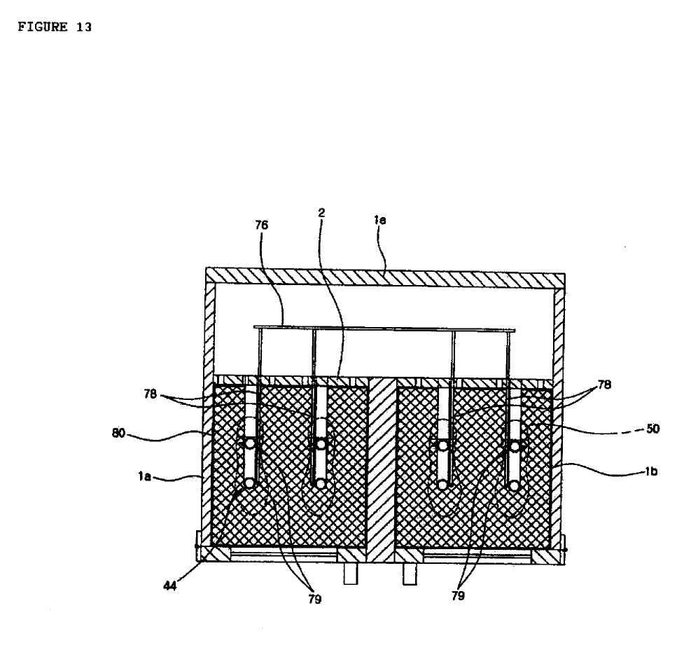

FIG. 11 shows cross-sectional view of the machine when the machine starts working, and FIG. 12 shows detail cross-sectional view of FIG. 11. Both FIGS. 11 and 12 shows detail structure of solution injector (70) which jets the solution into a shoe (50) which is placed on a shoe hanger (40). The solution is the solution which includes alkali, carbonated water, sodium hydrogen carbonate and enzyme. This solution helps stain, sweat, order and dirt inside of the shoe to soak out. (Referred here in after as ‘Solution’)

The solution injector (70) is installed on back panel (1e) of the machine (1). The solution is in a container (72), and there is a connected pipe (73) to the container. The container (72) is installed on the top of the housing (1) and is diverged to solution injector (74) in the perpendicular space (3) and solution supplying line (76) in the vertical panel (2). It is also connected to exhaust hole (40) on the shoe hanger (40).

Injecting of the Solution is completed by following steps, a pump (74) the solution to connected pipe (76) which is installed in back space column of the machine (3), and distribute the Solution to branched injecting passage (78) through vertical panel (2) and finally nozzle (79) located at the end of injecting passage (78) which is along with air exhaust pipe (44) and on outer surface top of the first and second air exhaust holes (44a) along with the first and second air exhausting holes (44a) and (44b) of air exhausting pipe (44) composing shoe hanger (40) injects the Solution inside of shoes (50).

Solution injecting pump (74) is controlled by a program in control system (100). When a user places shoes on the hanger, the sensor and the control system (100) starts working for appropriate time. The solution in the container (72) comes out through solution supplying line (76) and injecting nozzle (79) to soak out stain, sweat, odor and dirt absorbed inside of the shoes.

FIG. 1 and FIG. 9 shows how the machine sterilizes, deodorizes, and dries the shoe. The solution injecting pump (74) is composed with air compressor or small pressure pump.

FIG. 13 shows an example how it works when it is viewed from the top. The machine (1) is composed with left and right panels (1a) (1b) and vertical panel (2). The photocatalyst is scattered on the panels inside of the room (5). When photocatalyst receives lights (light: 7), active oxygen occurs and starts oxidizes and deodorizes the shoe.

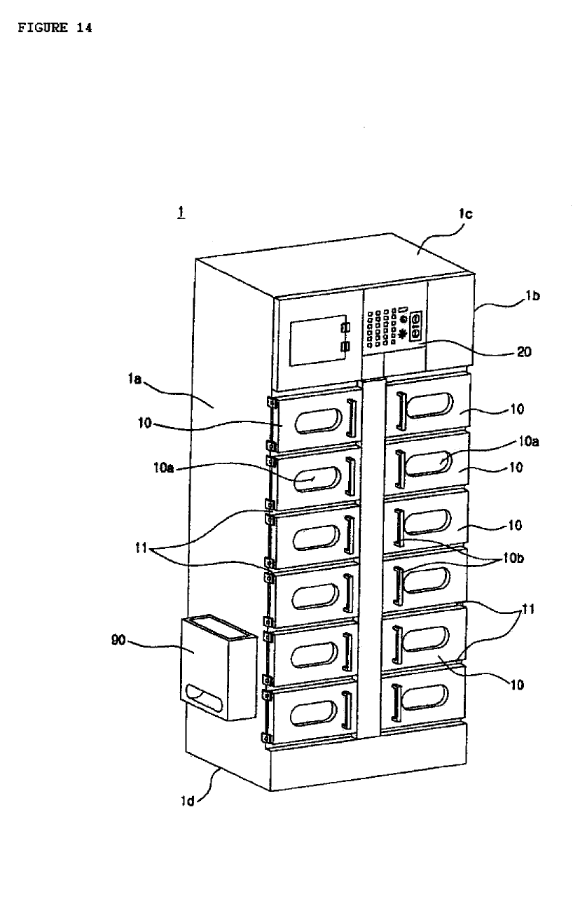

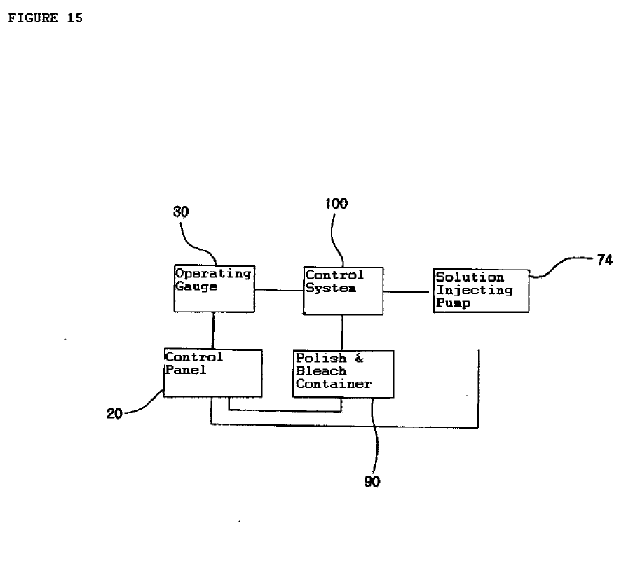

FIG. 14 shows perspective view of the machine when it is working. There is a container for polish and bleach (90) near left and right panels (1a) (1b) of the housing (1). This container is also controlled by control system (100). Once machine sterilizes, deodorizes and dries the shoes completely, the user opens the doors to take the shoes out. The machine says, “Please wipe the external side of shoe by using bleach and polish,” and bleach and polish come out automatically.

1. Shoes refreshing, washing and drying machine comprising:
Many rooms (5) are created by dividers (4) which are placed inside of the machine. There are doors (10) attached to each room of the machine (1). Control Panel (20) on the top front side of the machine (1) consists of buttons (21), screen (22), a slot to insert coins (23), each room number (24), password (25), and speaker (26). There are ventilating fan (31), electric heater (32), ultraviolet generator (33), ozone generator (34), anion generator (35) and nano generator (30) on operating gauge (30) in a case (38) which is located on the top of the machine where the control panel (20) is located as well. Control system (100) manages those devices. Vertical panel (2) is placed between main body of the machine (1) and back panel (1e). Perpendicular space (3) is created by placing top and bottom panels (1c) (1d). The ventilating fan (31), electric heater (32) are placed on vertical panel (2), so mixed air which includes ultraviolet layer, ozone, anion and nano created by generators (33, 34, 35, and 36) move into each room (5) through the mixed air intake hole (2a). The shoe hangers (40) are connected to vertical panel (2) horizontally in each room (5), so mixed air goes into the shoes (50) directly.

2. The shoes refreshing, washing and drying machine as mentioned in claim 1 has about 0.1 mm˜300 mm space between doors (10) and main body of the machine (11), and this space helps machine to maintain proper humidity and temperature inside of the machine.

3. The shoes refreshing, washing and drying machine as mentioned in claim 1 always maintains inside temperature 50 degree to 90 degree in order to dry wet shoes (50).
In order to maintain appropriate temperature, 0.1˜3 cm thick of metal is used for the housing (1).

4. The shoes refreshing, washing and drying machine as mentioned in claim 1 has anion generator (35) which receives power through PBC board (35a), and the generator transforms it into alternating current and boosts the voltage at the transformer (35b). By using condenser (35c), it amplifies and boosts the voltage.
Electric discharge blush (35c) and trans double controlled electric discharge panel (35e) are on the PBC board (35a), and those helps output of anions.

5. The shoes refreshing, washing and drying machine as mentioned in claim 4 has the electric discharge blush (35c) which is composed of 1000 fibers. About 200 millions of anions are discharged per 1 cc.

6. The shoes refreshing, washing and drying machine as mentioned in claim 1 has shoe hangers (40) that are horizontally connected to the vertical panel (2). The exhaust holes (44) are extended to the 1^{st} air exhaust hole (44a) on the top and the 2^{nd} air exhaust hole (44b) that are extended from center to top area. The 1^{st} and 2^{nd} air exhaust holes (44a) (44b) have lots of ventilation hole (46), so mixed air moves out freely.

7. The shoes refreshing, washing and drying machine as mentioned in claim 6 has the 1^{st} air exit on the exhaust hole (44) which has gold nano (42) inside and outside of the rim.

8. The shoes refreshing, washing and drying machine as mentioned in claim 6 has the 2^{nd} air exhaust hole (44b) which has a fastener (52) that that limits movement of shoes (50) placed on the hanger. The fastener (52) has horizontal holding structures (52a) (52b) that are diagonal to the both side of outer rim of the 2^{nd} air exhaust hole (44b). One of horizontal holding structures (52a) (52b) is horizontally connected to the perpendicular hanger (52), so this structure prevents any loss or misplacement of the shoes.

9. The shoes refreshing, washing and drying machine as mentioned in claim 6 has different sizes of holes on the exhaust hole. Those sizes of holes are getting bigger as mixed air moves top to bottom in the perpendicular space (3).

10. The shoes refreshing, washing and drying machine as mentioned in claim 1 has solution injector (70) which installed on the upper side of back panel (2e) of the machine (1). The machine jets the Solution into the shoes (50) through the solution injector.
Also, the solution injector (70) is connected to the solution container (72) which contains the solution that includes alkali, carbonated water, sodium hydrogen carbonate and enzyme. The solution container (72) is connected to the connecting panel (73) which is located on the top if the machine (1). The solution container (72) and solution injecting pump (74) are controlled by control system (100) of the machine.
The solution is controlled by solution injecting pump and moved through the solution applying line (76) located in vertical space (2) which is connected to the shoe hangers (40). The injecting nozzle (79) jets the solution into the shoes (50).

11. The shoes refreshing, washing and drying machine as mentioned in claim 1 has left panel (1a), right panel (1b), (1), vertical panel (2), and the dividers that creates rooms (5). Once rooms receive lights, the machine creates active oxygen by itself because photocatalyst (80) is scattered inside of the machine.

12. The shoes refreshing, washing and drying machine as mentioned in claim 1 has a container (90) which is attached to the outside of the machine (1). There is bleach and polish. The Control system (100) discharges bleach and polish automatically.
